(19) United States
(12) Patent Application Publication
(10) Pub. No.: US 2025/0361768 A1
(43) Pub. Date: Nov. 27, 2025

(54) METHOD OF ASSEMBLING AN INSULATING GLASS PANE HAVING TWO OUTER GLASSES AND AT LEAST ONE THIN GLASS BETWEEN THEM

(71) Applicant: Glaston Germany GmbH, Neuhausen-Hamberg (DE)

(72) Inventor: Ralf Wolter, Tiefenbronn (DE)

(73) Assignee: Glaston Germany GmbH, Neuhausen-Hamberg (DE)

(21) Appl. No.: 19/215,896

(22) Filed: May 22, 2025

(30) Foreign Application Priority Data
May 24, 2024 (DE) 10 2024 114 620.6

(51) Int. Cl. E06B 3/673

(52) U.S. Cl. CPC E06B 3/67386; E06B 3/67373

(57) ABSTRACT

A method for assembling an insulating glass pane includes two outer glasses and at least one thin glass therebetween. A first flexible spacer strand is applied to a first outer glass to form a first frame-shaped spacer in a first application station. After the application of the first spacer strand, the first outer glass is joined with a thin glass to form a glass assembly in a first pressing station. After joining of the glass assembly, a second flexible spacer strand is applied to the thin glass of the glass assembly to form a frame-shaped spacer. After application of the second spacer strand, the glass assembly is completed with at least a second outer glass to form a triple or quadruple insulating glass pane in a second pressing station.

### CROSS-REFERENCE TO RELATED APPLICATIONS

This application claims priority to the German application number DE 10 2024 114 620.6 filed on May 24, 2024, the entire content of which is fully incorporated herein with this reference.

### DESCRIPTION

### Field of the Invention

The invention is based on a method and a device for assembling a triple insulating glass pane. Triple insulating glass panes are produced industrially in large quantities in production lines, wherein a first, a second and a third glass sheet are successively fed to a device with an application station and a pressing station arranged downstream of the application station. Each of the stations has a horizontal conveyor on which the glass sheets are transported one behind the other in an upstanding position. Each horizontal conveyor works with a supporting wall on which the upstanding glass sheets are supported at an angle of a few degrees to the rear. The first and third glass sheets each form an outer glass of the finished insulating glass pane. The second glass sheet forms the middle glass of the finished insulating glass pane. In the application station, a flexible spacer strand is applied to each of the second and third glass sheets. In the pressing station, the three glass sheets are assembled to form a triple insulating glass pane and, if necessary, filled with a gas other than air.

### Background of the Invention

WO 2020/028056 A1 discloses triple insulating glass panes in which the middle glass is formed by a thin glass. The insulating glass pane has a thin glass with a thickness of 0.5 mm between two outer glasses with a thickness of 5 mm each. The thin glass is accordingly unstable. It bends and can break very easily. Insulating glass panes with thin glass, having a thickness of 2 mm or less, have been produced using rigid, prefabricated spacer frames. The effort required to assemble such insulating glass panes has therefore been very high to date.

WO 2021/126607 A1 discloses a method for assembling a triple insulating glass pane with an internal thin glass, in which a rigid spacer frame with the required dimensions is prefabricated and bonded to the thin glass. Thereafter, the upstandingly thin glass is joined to an outer glass in a pressing station.

US 2024/0167325 A1 discloses a method for assembling a horizontally positioned triple or quadruple insulating glass pane with at least one internal thin glass, in which components of the glass pane are stacked onto a horizontally lying outer glass. Prefabricated rigid spacer frames and glass sheets are placed on top of each other to form a stack. A sealant is applied between the spacer frames and the glass sheets. The entire stack is then conveyed horizontally into an oven press, where it is heated and pressed together.

It may be an object of the invention to provide a method for assembling an insulating glass pane containing two outer glasses and at least one thin glass between them, in which, in particular, the effort and/or time required to manufacture such an insulating glass pane is reduced.

This object of the invention may be achieved by a method having the features of the independent claim. Advantageous further embodiments are the subject of dependent claims.

### SUMMARY OF THE INVENTION

In the method according to the invention, a first flexible spacer strand is applied to a first outer glass to form a first frame-shaped spacer. The method for assembling the insulating glass panes is carried out using a device which comprises several stations arranged one behind the other. The method according to the invention is carried out with at least an application station, a first pressing station and a second pressing station. The first pressing station is arranged downstream of the application station. The second pressing station is arranged downstream of the first pressing station. The first flexible spacer strand is applied to the first outer glass in the application station. The first spacer strand can form a frame-shaped spacer on the first outer glass. After application of the first spacer strand, the first outer glass is joined with a thin glass to form a glass assembly. Joining of the first outer glass and the thin glass to form the glass assembly takes place in the first pressing station. During the joining process, the distance between the thin glass and the first outer glass can be reduced until the thin glass rests on the first spacer strand and has a predefined distance to the first outer glass. In particular, the distance between the thin glass and the first outer glass can be reduced transversely to the glass plane, especially while maintaining the parallelism of the thin glass and the first outer glass. Once the glass assembly has been joined together, a second flexible spacer strand is applied to the thin glass of the glass assembly to form a frame-shaped spacer. In particular, the second spacer strand can form a frame-shaped spacer on the thin glass. After application of the second spacer strand, the glass assembly is completed with at least a second outer glass to form a triple or quadruple insulating glass pane. Completion of the glass assembly to form a triple or quadruple insulating glass pane takes place in the second pressing station.

By thin glass is meant a glass sheet with a thickness of 2 mm or less. The thin glass forms a middle glass or inner glass in the finished insulating glass pane. An outer glass is a glass sheet with two opposing surfaces, a first surface of which faces the thin glass in the finished insulating glass pane and a second surface of which faces outwards on the finished glass pane. The first surface of the outer glass sheet thus forms an inner side within the finished glass pane. The second surface of the outer glass sheet thus forms an outer side of the finished insulating glass pane. The thickness of an outer glass sheet can be between 2 mm and 15 mm. In particular, it can range from 3 mm to 8 mm.

The invention may have (but which are not necessary) significant advantages. The invention makes it possible on an industrial scale to process upstanding thin glass with flexible spacer strands into a triple and/or quadruple insulating glass pane. The invention eliminates the need to apply a spacer strand to the stand-alone thin glass. Applying flexible spacer strands to thin glass can cause considerable problems. When applying the hot material of a thermoplastic spacer strand to a stand-alone thin glass, a large amount of heat would be introduced into the thin glass at certain points, causing far-reaching deformation. It becomes so wavy that further processing would not be possible. The present invention avoids this. A thermoplastic spacer strand applied to the outer glass is already sufficiently cooled when it is joined to the thin glass in the pressing station. In addition, when the thin glass is placed on the finished spacer, the heat is not applied to the thin glass at specific points, but essentially evenly along the entire edge. This can prevent unacceptably high deformations and waviness of the thin glass as well as unacceptably high distortion and stresses in the thin glass. A flexible spacer strand, which is pulled from a supply roll and applied to a glass sheet by machine, is under prestress, which would lead to an unacceptably high curvature of the thin glass if applied directly to a stand-alone thin glass. The present invention enables flexible spacer strands to be applied exclusively to an outer glass or to a thin glass sheet that has already been joined with an outer glass sheet to form a glass assembly. The glass sheets forming the outer glasses are inherently stable enough to absorb the forces acting on the glass sheet during a direct application of a flexible spacer strand. Due to their high inherent stability, outer glasses can compensate sufficiently well for the stresses introduced into the glass sheet when the spacer strand is applied. If an outer glass with the spacer strand applied along its entire edge is then assembled with the thin glass, this no longer causes any unacceptably high stresses and/or deformation of the thin glass. The inventor has surprisingly discovered that a thin glass, which has already been joined together with an outer glass sheet to form a glass assembly, is thereby sufficiently stabilized. The invention makes it possible to apply a flexible spacer strand to the thin glass of the glass assembly without causing unacceptably high stresses and/or deformation of the thin glass. Insulating glass panes containing thin glass can therefore be produced very quickly and with short cycle times using the invention. This makes them available in large quantities. Triple insulating glass panes containing thin glass can be produced in the same thickness as previous double insulating glass panes. Old insulating glass panes can therefore be replaced with better insulating triple insulating glass panes without the need for structural changes to window frames. This can simplify the modernization of buildings. Using a spacer, which is not yet pre-assembled in the shape of a frame, allows glass sheets in special formats and/or with non-rectangular outer contours to be easily and flexibly processed into insulating glass panes.

In a further embodiment, the thin glass and the outer glass comprising the first spacer strand can be conveyed upstandingly one after the other into the first pressing station, where they are joined together to form the glass assembly. The thin glass can be conveyed into the pressing station standing on its lower edge. The thin glass is conveyed through the application station standing on its edge without interruption, i.e., without stopping and without being processed otherwise by the application station. In particular, the glass assembly can be conveyed upstandingly into the pressing station after the spacer strand has been applied to the thin glass of the glass assembly.

In a further embodiment, the thin glass supported by a first pressing plate can be sucked onto the second pressing plate in the pressing station. For this purpose, the pressing station can have a suction device for sucking the thin glass onto the second pressing plate. The second pressing plate with the thin glass sucked onto it is then moved away from the first pressing plate. This is done by increasing the distance between the two pressing plates. The first outer glass is conveyed into the pressing station, where it is supported by the first pressing plate. The first outer glass can be positioned in the pressing station congruently or concentrically to the thin glass sucked onto the second pressing plate. After the thin glass has been joined to the first outer glass, the suction of the thin glass onto the second pressing plate is terminated. The edge length of the thin glass can be a few millimeters, for example 3 mm on each side, smaller than the edge length of the outer glass. In such a case, the thin glass can be raised in the pressing station and/or the first outer glass can be lowered until the thin glass is positioned concentrically to the first outer glass. Raising and/or lowering can be achieved, for example, by inclining a conveyor belt of the horizontal conveyor in the first pressing station by a corresponding angle before the glass sheet resting on the conveyor belt is sucked onto the corresponding pressing plate. Inclining a conveyor belt is known per se and is described, for example, in EP 1 769 130 B1. The first outer glass and the smaller thin glass are positioned in relation to each other in such a way that the edge of the thin glass lies completely inside the edge of the first outer glass. Such an insulating glass pane is also referred to as a “pane stepped on all four sides”. The sensitive edge of the thin glass can thus be better protected against damage.

In a further embodiment, the thin glass supported by the first pressing plate can first be sucked onto the first pressing plate in the pressing station. The second pressing plate is placed against the thin glass, meanwhile the suction of the thin glass against the first pressing plate is maintained. The thin glass is sucked onto the second pressing plate before the suction of the thin glass onto the first pressing plate is terminated. The thin glass is therefore held between the two pressing plates of the first pressing station for a certain period of time and is sucked onto both pressing plates simultaneously. This ensures particularly good planarity of the thin glass. Full-surface suction of the thin glass can reduce distortion of the thin glass when it is subsequently placed on a still-warm thermoplastic spacer strand.

In a further embodiment, a triple insulating glass pane can be produced, in particular, in the manner: Before the first spacer is applied to the first outer glass, the second outer glass and the thin glass are conveyed through the application station in a standing position one after the other. The second outer glass can be transported through the first pressing station without interruption and without processing. The second outer glass is conveyed upstandingly into the second pressing station. During conveying, the second outer glass can be supported by a first pressing plate of the second pressing station. In the second pressing station, the second outer glass can be sucked onto a second pressing plate of the second pressing station. The second pressing plate with the second outer glass sucked onto it can be moved away from the first pressing plate of the second pressing station. Following after the second outer glass, the thin glass is conveyed upstandingly into the first pressing station. After the first spacer strand has been applied, the first outer glass is conveyed upstandingly from the application station into the first pressing station. The thin glass may already be in the first pressing station. In the first pressing station, the thin glass and the first outer glass are joined together to form the glass assembly. To apply the second spacer strand to the thin glass, the glass assembly can be conveyed back to the application station arranged upstream of the first pressing station. After the second spacer strand has been applied to the thin glass of the glass assembly, the glass assembly is conveyed upstandingly into the second pressing station. After the second outer glass has been moved away from the first pressing plate, the glass assembly can be conveyed into the second pressing station, where it is supported by the first pressing plate of the second pressing station, in particular, on the first outer glass. In the second pressing station, the glass assembly and the second outer glass are joined together to form a triple insulating glass pane. During joining, the glass assembly and the second outer glass can be parallel to each other. During assembly, the distance between the second outer glass and the glass assembly can be reduced until the second outer glass rests on the second spacer strand and the first outer glass has a predefined distance to the second outer glass. After joining, the suction of the second outer glass can be terminated and the triple insulating glass pane is conveyed upstandingly out of the second pressing station.

In a further embodiment, a quadruple insulating glass pane can be produced, in particular, in the following manner: A third flexible spacer strand is applied to the second outer glass sheet to form a third frame-shaped spacer. Before the first spacer strand is applied and before the third spacer strand is applied, the second thin glass can be conveyed upstandingly through the application station and into the first pressing station. Following after the second thin glass, the second outer glass can be conveyed upstandingly into the application station. In the application station, the third flexible spacer strand can be applied to the second outer glass. After the third spacer strand has been applied, the second outer glass is joined with a second thin glass to form a second glass assembly, in particular, in the first pressing station. For joining, the second outer glass can be conveyed upstandingly from the application station into the first pressing station. In particular, the second thin glass can already be located there. During joining, the distance between the second thin glass and the second outer glass can be reduced until the second thin glass rests on the third spacer strand and has a predefined distance to the second outer glass. Following after the second outer glass, the first thin glass can be conveyed through the application station. Following after the first thin glass, the first outer glass can be conveyed upstandingly into the application station. In the application station, the first flexible spacer strand can be applied to the first outer glass. After the second glass assembly has been joined together, it can be conveyed upstandingly from the first pressing station into a turning station. In the turning station, the second glass assembly can be rotated about an upstanding axis of rotation and thus turned. Following after the second glass assembly, the first thin glass can be conveyed upstandingly into the first pressing station. After turning, the second glass assembly can be conveyed upstandingly from the turning station into the second pressing station. The second glass assembly can be supported by a first pressing plate of the second pressing station, in particular, on the second thin glass. In the second pressing station, the second outer glass of the second glass assembly can be sucked onto a second pressing plate of the second pressing station. In the second pressing station, the second pressing plate with the second glass assembly sucked onto it can be moved away from the first pressing plate. After the first spacer strand has been applied to the first outer glass, it can be conveyed upstandingly from the application station into the first pressing station. In particular, the first thin glass can already be located there. In the first pressing station, the first thin glass and the first outer glass can be joined together to form the first glass assembly. After the first glass assembly has been joined together, the second flexible spacer strand can be applied to the first thin glass of the first glass assembly. To apply the second spacer strand to the first thin glass, the first glass assembly can be conveyed back to the application station arranged upstream of the first pressing station. After the second spacer strand has been applied to the first thin glass of the first glass assembly, the first glass assembly can be conveyed upstandingly into the second pressing station. The first glass assembly can be supported by the first pressing plate of the second pressing station, in particular, on the first outer glass. In particular, the second glass assembly, may already be located in the second pressing station and had been moved away from the first pressing plate. In particular, the first glass assembly can be conveyed through the turning station without turning. The first glass assembly with the second spacer strand applied to it and the previously assembled second glass assembly are joined together to form a quadruple insulating glass pane, namely in the second pressing station. In particular, the distance between the first glass assembly and the second glass assembly is reduced until the second thin glass of the second glass assembly rests on the second spacer strand and the first outer glass has a predefined distance to the second outer glass. After the first glass assembly has been joined to the second glass assembly, the suction of the second outer glass to the second pressing plate of the second pressing station can be terminated. After the joining and/or after terminating the suction of the second outer glass, the quadruple insulating glass pane can be conveyed upstandingly out of the second pressing station.

In a further embodiment, the method according to the invention can be carried out with a first application station and a second application station. The first pressing station is arranged downstream of the first application station. The second application station is arranged between the first pressing station and the second pressing station, in particular, between a turning station and the second pressing station. The first spacer strand is applied to the first outer glass in the first application station. When assembling a triple insulating glass pane, the glass assembly can be conveyed into the second application station for applying the second spacer strand to the thin glass of the glass assembly. When assembling a quadruple insulating glass pane, the third spacer strand can be applied to the second outer glass in the first application station. When assembling a quadruple insulating glass pane, the first glass assembly can be conveyed into the second application station to apply the second spacer strand to the first thin glass of the first glass assembly. The use of two application stations ensures that the glass sheets and/or glass assemblies are only transported through the production line in the main conveying direction. A return transport to an upstream station can be avoided and the production time can be further reduced.

A turning station can be arranged downstream of the first pressing station. The turning station has two parallel supporting walls and a horizontal conveyor. The horizontal conveyor can be rotated together with the two supporting walls about an upstanding axis of rotation. The turning station is configured to turn a glass assembly standing on the horizontal conveyor 180° around an upstanding axis of rotation. Seen along the conveying direction, the axis of rotation is arranged centrally in relation to the horizontal conveyor. As a result, after a 180° rotation, the horizontal conveyor is again in the same line as before the rotation. A second pressing station is arranged downstream of the turning station. Both the turning station and the two pressing stations, in particular, all stations of the device according to the invention, can each contain only one single-track horizontal conveyor. The term “single-track” refers to a horizontal conveyor which has only one conveyor track. The horizontal conveyor can be configured to convey standing glass sheets in a straight line through the respective station. All horizontal conveyors can be arranged one behind the other along a straight line. Both the first pressing station and the second pressing station can be designed as follows. The pressing station has two parallel pressing plates. A first of the two pressing plates forms an upstanding supporting wall for a glass sheet transported upstandingly on a horizontal conveyor. The feature “upstanding” means that the supporting wall is not exactly vertical or aligned with a plummet but is inclined backwards by a few degrees so that an upstanding glass leaning against the supporting wall does not tip forwards, i.e., away from the supporting wall. A supporting wall can have an inclination of around 6° to 8° to the vertical. A second of the two pressing plates can be displaceable transversely to the first pressing plate in order to change the distance between the two pressing plates. When the second pressing plate is displaced, the parallelism of the second pressing plate to the first pressing plate can be maintained. The pressing station can have a suction device for sucking a glass sheet onto the second pressing plate. The pressing station can be configured to fill the space between the glass sheets with a gas other than air. The structure and mode of operation of such pressing stations is known per se from decades of use in the industrial manufacture of insulating glass panes and from EP 0 539 407 B1 and EP 1 769 130 B1 and therefore does not need to be described in more detail.

In the application station, a flexible spacer strip is applied to an upstanding glass sheet along its edge in a manner known per se. This means that no pre-assembled spacer frame is placed on the glass sheet. The spacer strand can be applied without gaps along the edge of the glass sheet. A spacer strand applied along the entire edge of the glass sheet creates a spacer frame to keep two adjacent glass sheets at a distance. The flexible spacer strand can be a pasty and thereafter solidifying spacer strand made of a thermoplastic material and/or a reactive cross-linking material, which strand is applied to the glass sheet using a nozzle. The flexible spacer strand is therefore still hot and/or not yet fully cured after application. The flexible spacer strand can also be unrolled from a supply roll as a ribbon-shaped material and applied to the glass sheet. The application station can contain an application head, which is guided along at least a section of the edge of the outer glass in order to apply the spacer strand. The application station is configured to apply a flexible spacer strand along an edge of a thin glass of a standing glass assembly.

In a further embodiment, one of the stations can have an air cushion supporting wall with a planar supporting surface. The supporting wall is configured to support a glass sheet transported upstandingly on the horizontal conveyor. A plurality of air ducts can open into the supporting surface. An air flow emerges obliquely to the supporting surface from the air ducts when subjected to positive pressure. This creates an air cushion on the supporting surface on which the transported glass sheet, in particular, the thin glass, can rest and slide without touching the supporting surface. An obliquely upward blowing flow is generated on the supporting wall. This means that a machine operator standing in front of the station is not blown at directly. At least one of the air ducts, in particular, each of the air ducts, can contain an end duct section that extends obliquely to the supporting surface. In a vertical section through the supporting wall, the end duct section can extend at an angle of 45° or less, in particular, from 30° to 45°, to the supporting surface. Such an inclined blowing flow can create an air cushion that makes it much easier to transport thin glass. In particular, the first pressing station can contain such an air cushion supporting wall. The air cushion supporting wall can be formed by the first pressing plate. An intermediate station, which contains a horizontal conveyor and an air cushion supporting wall according to the invention, can be arranged between the application station and the first pressing station.

At least one of the pressing plates, in particular, the first pressing plate of the first pressing station, can have a planar supporting surface into which a plurality of air ducts open, wherein the air ducts form suction devices when subjected to negative pressure in order to suck a thin glass planar onto the supporting surface. The air ducts in the pressing plate can be pressurized with either negative or positive pressure. This allows the functions of a suction device and an air cushion supporting wall to be combined in the pressing plate. As a result, a pressing plate can either act as an air cushion supporting wall for transportation or hold a glass sheet in place by suction during assembly.

The supporting surface can have at least one depression which is connected to an end duct section of the air duct. The depression can be circular, in particular, with a diameter of 20 mm or less. A depression may be provided for each end duct section. The depression may surround the end duct section. The depression is open towards the supporting surface. The supporting surface can have at least one groove which is connected to an end duct section. In particular, the groove can extend from a depression surrounding the end duct section. The groove extends along the supporting surface and is open towards the supporting surface. The end duct section can open into the depression or the groove at an angle. All end duct sections can extend parallel to each other.

When processing thin glass with a thickness of 2 mm or less, the width of the groove is 20 mm or less. When processing thin glass with a thickness of 1.5 mm or less, the width of the groove can, in particular, be 15 mm or less. When processing thin glass with a thickness of 1 mm or less, the width of the groove can, in particular, be 10 mm or less. This ensures that the thin glass extending over the groove without support is not impermissibly deformed by the negative pressure prevailing in the air duct. The thin glass can thus be sucked onto the supporting surface in a particularly planar manner and without undesirable waviness.

The groove can contain at least two groove sections that extend at an angle to each other. Each groove section extends along a straight line. Each of the groove sections can have a length of 60 mm or less. This is a particularly good way of preventing the thin glass from being elastically deformed by the negative pressure and bulging into the groove. Several grooves can be arranged in the supporting surface, which grooves are connected to an end duct section. In a plan view of the supporting surface, several grooves can extend radially towards the one end duct section. The grooves can, for example, be arranged like radiated beams around the one end duct section.

In a further embodiment, the supporting surface can have a first supporting region and a second supporting region. An air duct density in the first supporting region can be greater than in the second supporting region of the supporting surface. The air duct density in a supporting region is defined as the number of air ducts that open into this supporting region divided by the total area of this supporting region. The first supporting region can extend along the edge in the lower region of the supporting wall. When subjected to positive pressure, more air jets out of the first supporting region. This reliably prevents the lower edge of the thin glass from hitting the supporting surface during transportation on the horizontal conveyor. A suctioned area fraction of the surface area in the first supporting region that is suctioned by the air ducts can be larger than in the second supporting region, in particular, by increasing the area subjected to negative pressure by depressions and/or grooves. The suctioned surface area fraction in a supporting region is the area subjected to negative pressure divided by the total area of this supporting region. The thin glass can thus be sucked onto the supporting surface in a particularly planar manner.

### BRIEF DESCRIPTION OF THE DRAWINGS

Further details and advantages of the invention are explained with reference to embodiments of the invention and the attached drawings. Identical and corresponding components are provided therein with corresponding reference signs.

FIG. 1 is a schematic top view of a structure of a device and some intermediate steps in a first embodiment of a method according to the invention for assembling a quadruple insulating glass pane,

FIG. 2 shows the device of FIG. 1 with further intermediate steps during assembly of the quadruple insulating glass pane,

FIG. 3 is a schematic side view of a finished triple insulating glass pane,

FIG. 4 is a schematic side view of a finished quadruple insulating glass pane,

FIG. 5 is a schematic front view of a turning station for the device of FIG. 1, FIG. 6 is a schematic top view of the turning station of FIG. 5,

FIG. 7 is a schematic side view of the turning station of FIG. 5,

FIG. 8 is a schematic front view of a supporting wall for the device of FIG. 1, FIG. 9 is an enlarged view of a region X of FIG. 8,

FIG. 10 is an enlarged view of a vertical section through the supporting wall in region X,

FIG. 11 shows the device of FIG. 1 and some intermediate steps in an embodiment of a method according to the invention for assembling a triple insulating glass pane,

FIG. 12 shows the device of FIG. 11 with further intermediate steps during assembly of the triple insulating glass pane,

FIG. 13 shows a variation of a device similar to FIG. 1 as well as some intermediate steps in a further embodiment of a method according to the invention for assembling a quadruple insulating glass pane,

FIG. 14 shows the device of FIG. 13 with further intermediate steps during assembly of the quadruple insulating glass pane,

FIG. 15 shows a variation of a device similar to FIG. 1 as well as intermediate steps in a further embodiment of a method according to the invention for assembling a triple insulating glass pane.

### DETAILED DESCRIPTION OF EMBODIMENTS OF THE INVENTION

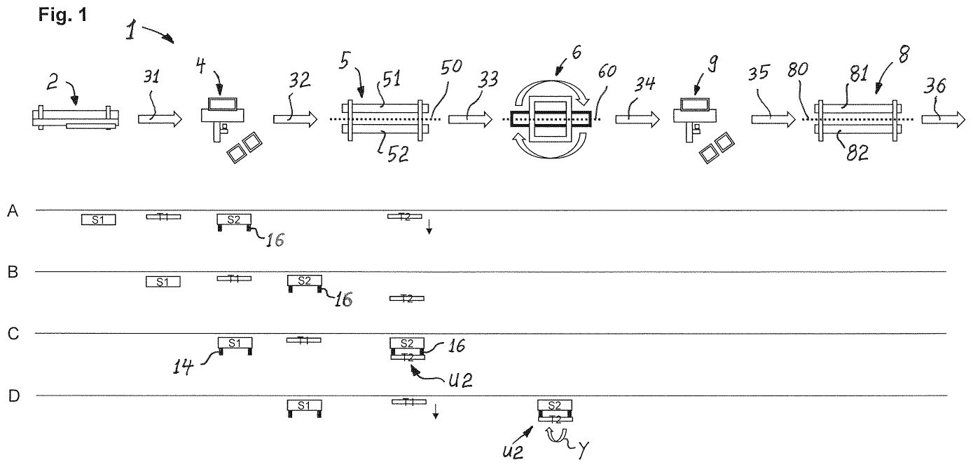

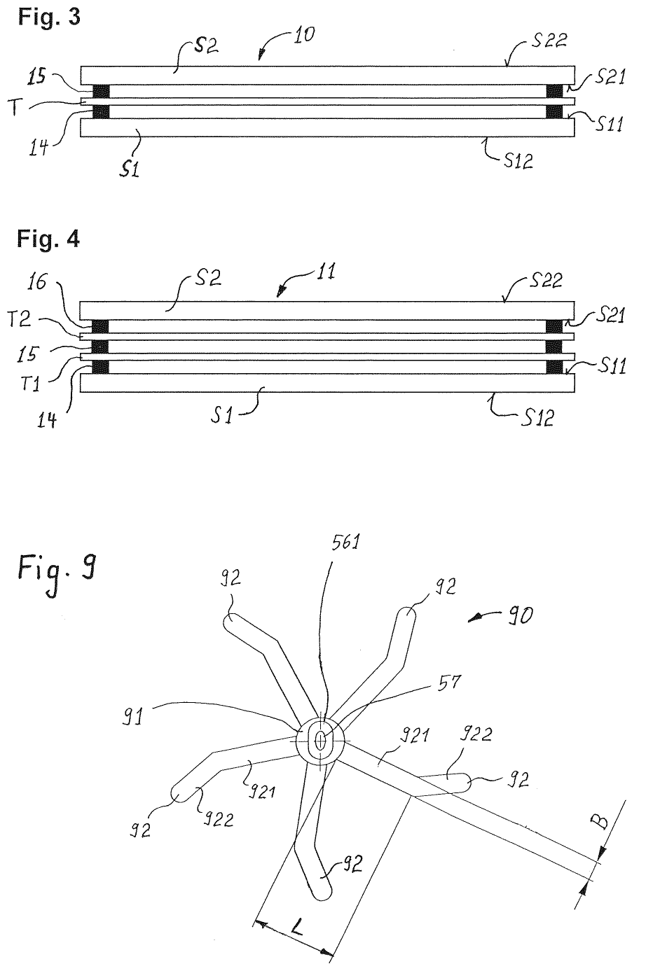

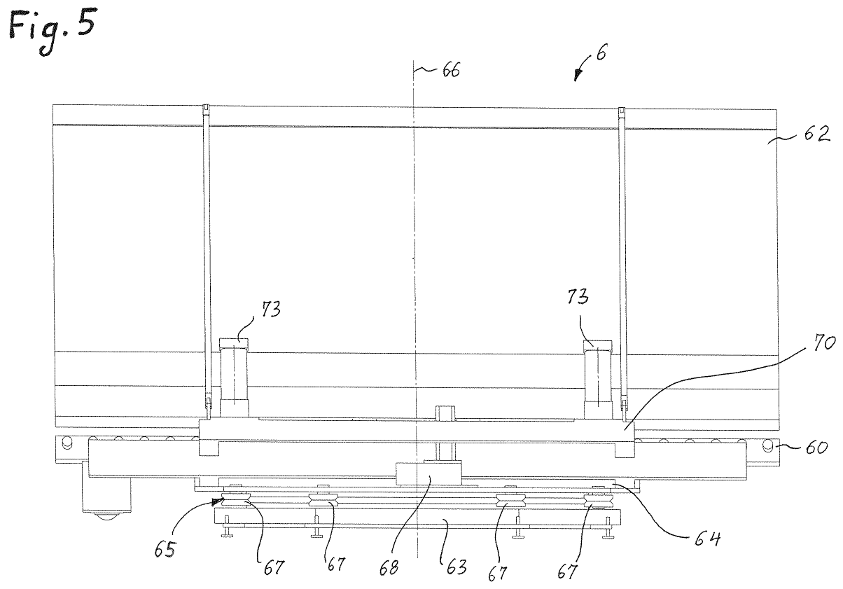

FIGS. 1, 2 and 11, 12 each show a device 1 for assembling insulating glass panes 10, 11, which device is designed as a single-track production line. A triple insulating glass pane 10 contains three glass sheets S1, T and S2, see FIG. 3. A quadruple insulating glass pane 11 contains four glass sheets S1, T1, T2 and S2, see FIG. 4. The glass sheets T as well as T1 and T2 are each a thin glass with a thickness of 1 mm or less. The glass sheet S1 is a first outer glass with a first surface S11, which faces the thin glass T or T1 and forms an inner side of the insulating glass pane 10 or 11. A second surface S12 of the outer glass sheet S1 forms an outer side of the insulating glass pane 10 or 11. The glass sheet S2 is a second outer glass which has a first surface S21 and a second surface S22, which correspondingly form an inner side and an outer side of the insulating glass pane 10 or 11, respectively. In the insulating glass pane 10, a first flexible spacer strand 14 is arranged between the first outer glass S1 and the thin glass T. The spacer strand 14 forms a spacer frame known per se along the edge of the outer glass S1, which holds the two glass sheets S1 and T at a predefined distance from one another. Accordingly, a second flexible spacer strand 15 is arranged between the second outer glass S2 and the thin glass T. In the case of the insulating glass pane 11, a first flexible spacer strand 14 is arranged between the first outer glass S1 and the first thin glass T1. A second flexible spacer strand 15 is arranged between the first thin glass T1 and the second thin glass T2. A third flexible spacer strand 16 is arranged in a corresponding manner between the second outer glass S2 and the second thin glass T2.

The device 1 contains an inspection station 2, several intermediate stations, two application stations 4 and 9, two pressing stations 5 and 8 and a turning station 6. The intermediate stations 31, 32, 33, 34 and 35 are provided between the other stations as a transport track and/or intermediate storage. The intermediate station 36 is arranged downstream of the second pressing station 8 for removing the finished insulating glass pane 10, 11. The intermediate stations 31, 32, 33, 34, 35 and 36 can each contain a single-track horizontal conveyor and a supporting wall (both not shown) in a manner known per se.

In a first embodiment of the production of the quadruple insulating glass pane 11 according to the invention, the second thin glass T2 is fed to the inspecting station 2 as the first glass sheet and checked there for defects. The thin glass T2 is then conveyed upstandingly in the main conveying direction through the intermediate station 31, the first application station 4 and the intermediate station 32 to the first pressing station 5. The second outer glass S2 is fed as a second glass sheet. After being checked for defects in the inspection station 2, the outer glass S2 is conveyed via the intermediate station 31 into the first application station 4. The first thin glass T1 is fed to the inspection station 2 as the third glass sheet. After being checked for defects, the thin glass T1 is conveyed into the intermediate station 31. The first outer glass S1 is then conveyed into the inspection station 2 as the fourth glass sheet and checked there for defects. In the first application station 4, the third spacer strand 16 is applied to the outer glass S2, so that a closed spacer frame is formed along the edge of the outer glass S2 in a manner known per se, see intermediate step A in FIG. 1.

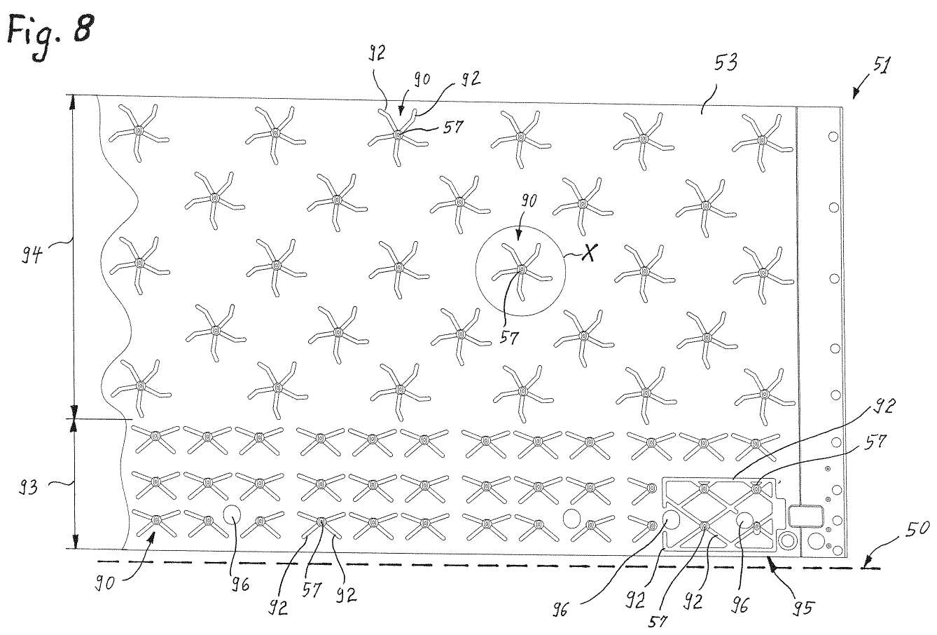

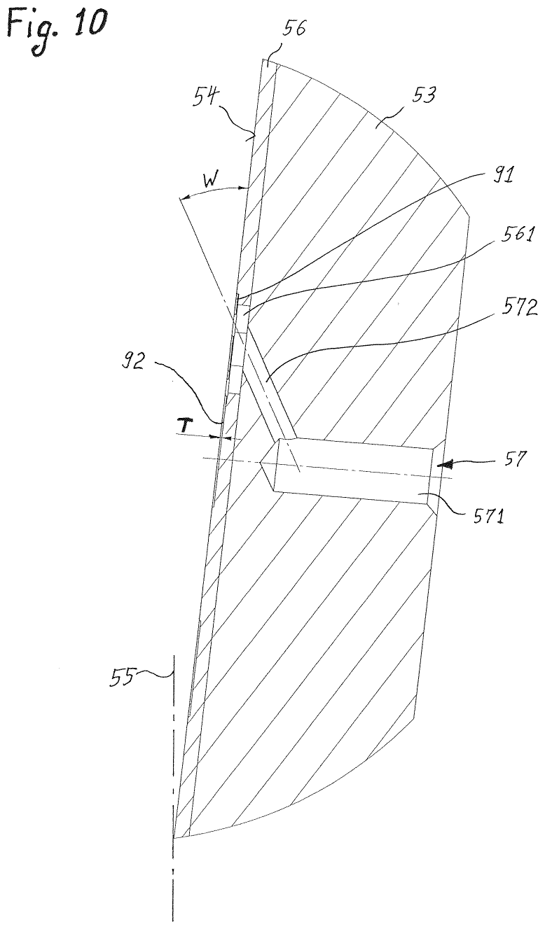

The first pressing station 5 has a single-track horizontal conveyor 50, a first pressing plate 51 and a second pressing plate 52. The horizontal conveyor 50 is designed in a manner known per se and is indicated schematically by a dashed line. The first pressing plate 51 is arranged in a fixed position. The upstanding pressing plate 51 is inclined slightly backwards relative to the vertical and supports the thin glass T2 standing on the horizontal conveyor 50 so that it does not tip forwards, i.e., to the side facing away from the pressing plate 51. The pressing plate 51 forms a supporting wall 53 with a planar supporting surface 54. The vertical or plumb line is indicated in FIG. 10 as a dotted line 55. The supporting surface 54 is formed by a rubber coating 56 on the supporting wall 53. The supporting wall 53 is designed as an air cushion supporting wall, which contains a plurality of air ducts 57. The air ducts 57 open into the supporting surface 54, see FIGS. 8 to 10. A first duct section 571 of the air duct 57 is formed by a blind hole drilled into the supporting wall 53 from the rear. An end duct section 572 of the air duct 57 is connected to the duct section 571 and extends at an angle W oblique to the supporting surface 54. The angle W is 30°. The end duct section 572 has a diameter of 3 mm to 6 mm, in particular, 4 mm. When positive pressure is applied to the air duct 57, an air flow thus exits obliquely to the supporting surface 54. In order not to obstruct the air flow emerging from the supporting surface 54, the rubber coating 56 contains an oval hole 561 which surrounds the end duct section 572. The air duct 57 thus extends as a through channel through the supporting wall 53 to a side of the supporting wall 53 opposite the supporting surface 54.

The second pressing plate 52 is arranged parallel to the first pressing plate 51 and to the supporting surface 54. The pressing plate 52 can be displaced linearly transversely to the conveying direction of the horizontal conveyor 50, so that the distance between the two pressing plates 51 and 52 changes. The pressing plate 52 contains a suction device (not shown), which can suck a glass sheet supported by the pressing plate 51 onto the pressing plate 52. The pressing plate 52 with the glass sheet sucked onto it can then be moved away from the pressing plate 51.

The thin glass T2 is sucked onto the pressing plate 52 and moved away from the pressing plate 51 with it. This is explained in more detail below. After the spacer strand 16 has been applied to the outer glass S2, it is conveyed into the intermediate station 32. The thin glass T1 and the outer glass S1 are transported to follow the outer glass S2, see intermediate step B in FIG. 1.

The horizontal conveyor 50 becomes free when the thin glass T2 sucked onto the pressing plate 52 has moved away from the pressing plate 51. The outer glass S2 can then be conveyed into the pressing station 5 by the horizontal conveyor 50 until it stands congruent with the thin glass T2. The pressing plate 52 with the thin glass T2 sucked onto it is then moved back towards the pressing plate 51 until the thin glass T2 rests on the spacer strand 16 and has a predefined distance to the outer glass S2. Before the thin glass T2 rests completely on the spacer strand 16, the space between the thin glass T2 and the outer glass S2 can be filled with a gas other than air in a manner known per se. The second thin glass T2 and the second outer glass S2 are then joined together to form a glass assembly U2, which is referred to as the “second glass assembly”. The thin glass T1 is transported to the intermediate station 32. The outer glass S1 is conveyed into the application station 4 and the spacer strand 14 is applied to the outer S1, see intermediate step C in FIG. 1.

The distance between the pressing plates 51 and 52 is increased again and the second glass assembly U2 is conveyed into the turning station 6 via the intermediate station 33. At the same time, the thin glass T1 is conveyed into the pressing station 5, see intermediate step D in FIG. 1.

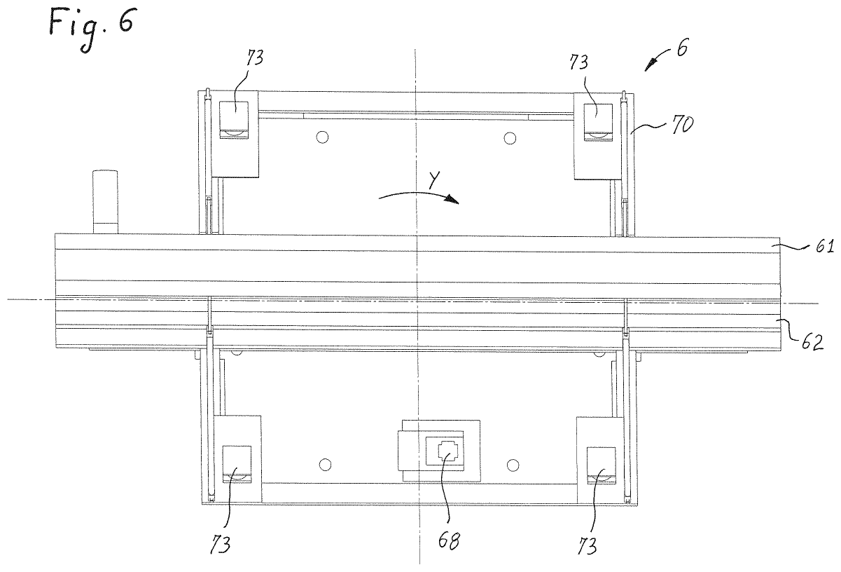

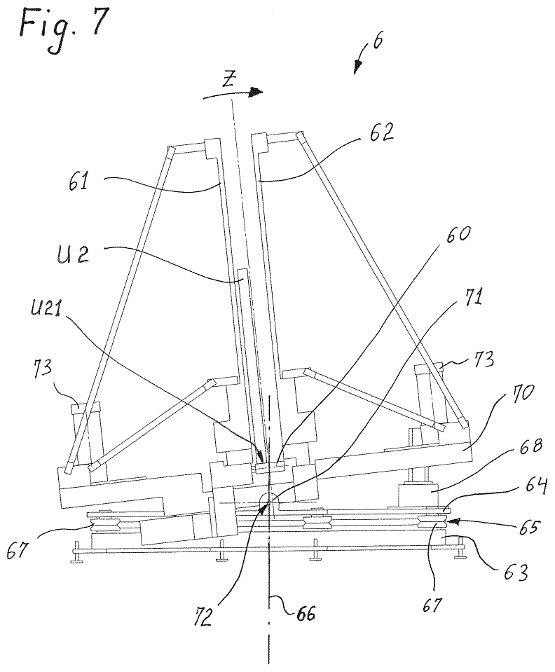

The turning station 6 has a single-track horizontal conveyor 60, a first supporting wall 61 and a second supporting wall 62, see FIGS. 5 to 7. The horizontal conveyor 60 is designed in a manner known per se. Furthermore, the turning station 6 has a base frame 63 which stands stationary on the floor and to which a rotary frame 64 is mounted. A swivel joint 65 having a vertical axis of rotation 66 is arranged between the rotary frame 64 and the base frame 63. The swivel joint 65 is designed as a slewing ring with several guide rollers 67 arranged along the circumference. The turning station 6 contains a rotary drive 68, by which the rotary frame 64 can be rotated in the direction of the arrow Y about the axis of rotation 66. A tilting frame 70 is attached to the rotary frame 6. A tilting joint 71 with a horizontal tilting axis 72 is arranged between the rotary frame 64 and the tilting frame 70. The tilting axis 72 extends perpendicular to the drawing plane in FIG. 7. Tilting drives 73 in the form of pressure medium cylinders are provided in order to tilt the tilting frame 70 relative to the rotary frame 64 in the direction of the arrow Z about the tilting axis 72.

When the glass assembly U2 is conveyed from the pressing station 5 into the turning station 6 standing on its lower edge U21, the glass assembly U2 is supported on the outside S22 of the glass sheet S2. The horizontal conveyors 50 and 60 are in line and the supporting wall 61 is in one plane with the pressing plate 51 when the glass assembly U2 is conveyed into the turning station 6. The glass assembly U2 is then rotated by 180° in the direction of arrow Y via the rotary drive 68 and thus turned. Simultaneously with the rotary movement in the direction of arrow Y, the glass assembly U2 is tilted in the direction of arrow Z via the tilting drives 73. When the horizontal conveyor 60 is tilted together with the supporting walls 61 and 62, the glass assembly U2 also tilts away from the supporting wall 61 and towards the supporting wall 62. After the tilting process is complete, the glass assembly U2 is supported on the thin glass sheet T2 by the supporting wall 62. After completion of the turning and tilting process, the horizontal conveyor 60 is again aligned with the horizontal conveyor 50 and the supporting wall 62 is in one plane with the pressing plate 51, see intermediate step E in

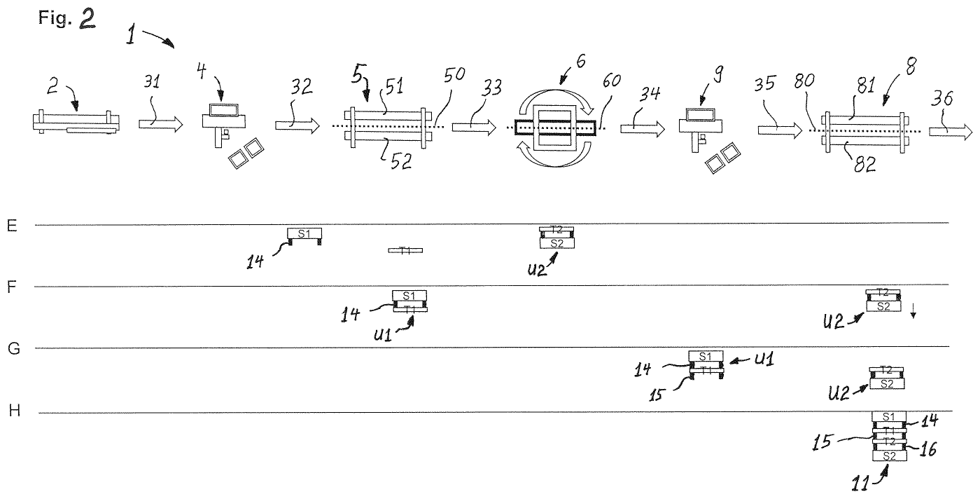

FIG. 2. During the turning process, the thin glass T1 is sucked onto the pressing plate 52 and moved away from the pressing plate 51 with it.

After the glass assembly U2 has been turned, it is supported on the thin glass 11 and conveyed into the second pressing station 8. The horizontal conveyor 50 becomes free when the thin glass T1 sucked onto the pressing plate 52 has moved away from the pressing plate 51. The outer glass S1 can then be conveyed into the pressing station 5 by the horizontal conveyor 50 until it stands congruent with the thin glass sheet T1. The pressing plate 52 with the thin glass T1 sucked onto it is then moved back towards the pressing plate 51 until the thin glass T1 rests on the spacer strand 14 and has a predefined distance to the outer glass S1. Before the thin glass T1 rests completely on the spacer strand 14, the space between the thin glass T1 and the outer glass S1 can be filled with a gas other than air in a manner known per se in order to increase the insulating effect. The first thin glass T1 and the first outer glass S1 are then joined together to form a glass assembly U1, which is also referred to as the “first glass assembly”, see intermediate step F in FIG. 2.

The first glass assembly U1 is conveyed from the pressing station 5 via the intermediate station 33 upstandingly through the turning station 6 without turning. The glass assembly U1 is supported on the outside S12 by the supporting wall 62. The glass assembly U1 is conveyed into the second application station 9 via the intermediate station 35. In the second application station 9, the second spacer strand 15 is applied to the first thin glass T1, so that a closed spacer frame is formed along the edge of the thin glass T1 in a manner known per se, see intermediate step G in FIG. 2.

The second pressing station 8 has a single-track horizontal conveyor 80, a first pressing plate 81 and a second pressing plate 82. The first pressing plate 81 is arranged in a fixed position and is inclined slightly backwards in relation to the vertical. The pressing plate 81 supports the glass assembly U2 standing on the horizontal conveyor 80 so that it does not tip forwards, i.e., to the side facing away from the pressing plate 81. The pressing plate 81 forms an air cushion supporting wall with a planar supporting surface, which is arranged in one plane with the supporting surface 54 of the pressing plate 51. The second pressing plate 82 is arranged parallel to the pressing plate 81 and can be displaced linearly transversely to the conveying direction of the horizontal conveyor 80, so that the distance between the two pressing plates 81 and 82 changes. The pressing plate 82 contains a suction device (not shown) known per se, which can suck a glass assembly U2 supported by the pressing plate 81 onto the pressing plate 82. The glass assembly U2 is sucked onto the pressing plate 82 at the outer glass S2. The pressing plate 82 with the glass assembly U2 sucked onto it is then moved away from the pressing plate 81. Thus, the horizontal conveyor 80 becomes free, see intermediate step G in FIG. 2.

The glass assembly U1 is conveyed from the horizontal conveyor 80 into the pressing station 8 via the intermediate station 35. When the outer glass S1 is congruent with the outer glass S2, the pressing plate 82 with the glass assembly U2 sucked onto it is moved back towards of the pressing plate 81. The distance between the two pressing plates 81 and 82 is reduced until the thin glass T2 rests on the spacer strand 15 and the first outer glass S1 has a predefined distance to the second outer glass S2, see intermediate step H in FIG. 2. Before the thin glass T2 rests completely on the spacer strand 15, the space between the thin glass T2 and the thin glass T1 can be filled with a gas other than air in a manner known per se.

The suction of the outer glass S2 to the pressing plate 82 is terminated and the distance between the pressing plates 81 and 82 is increased again. The assembled quadruple insulating glass pane 11 is then transported away via the horizontal conveyor 80 and the intermediate station 36. During conveying, the upstanding insulating glass pane 11 is supported on the outside S12.

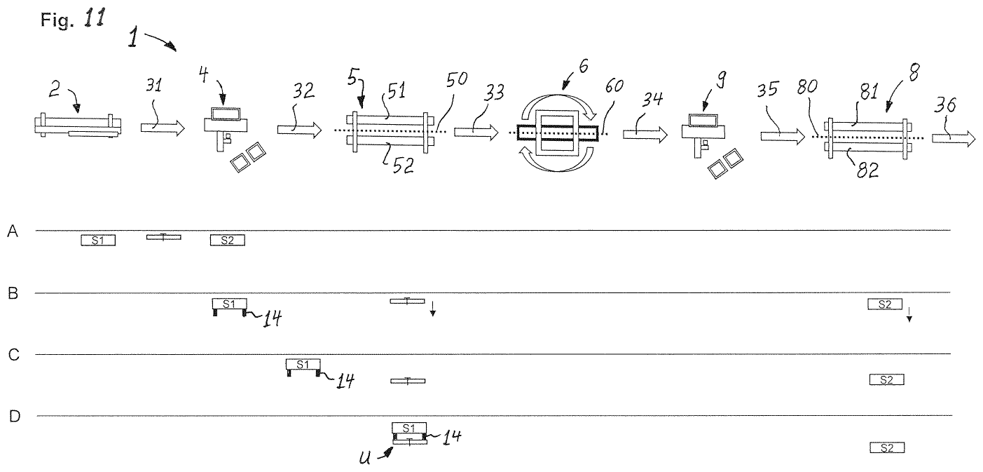

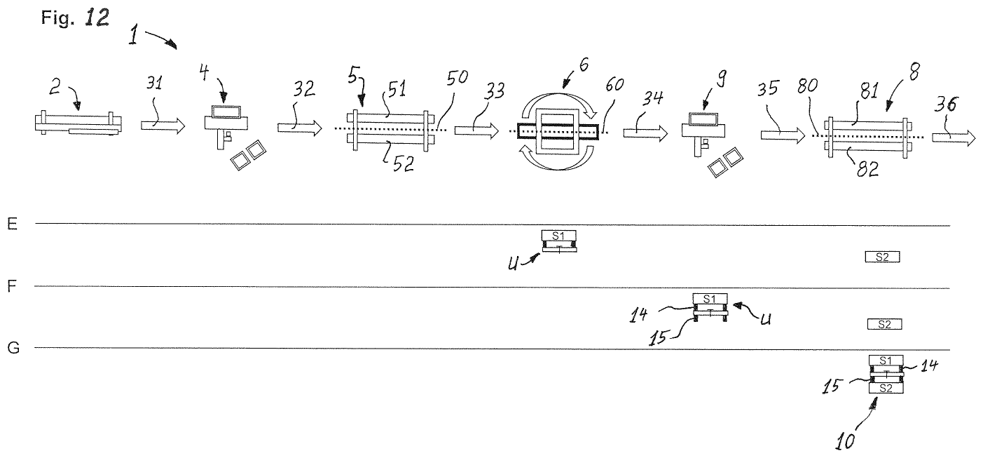

In an embodiment of the production of the triple insulating glass pane 10 according to the invention, the same device 1 is used as in the production of the quadruple insulating glass pane 11 described above. The second outer glass S2 is fed in as the first glass sheet. The thin glass T is then fed as the second glass sheet. The third glass sheet is the first outer glass S1, see intermediate step A in FIG. 11. After checking the respective glass sheet in the inspection station 2, the outer glass S2 is fed into the pressing station 8 without being processed otherwise. The thin glass T is conveyed into the pressing station 5. In the application station 4, the first spacer strand 14 is applied to the outer glass S1, see intermediate step B in FIG. 11. The thin glass T is sucked onto the pressing plate 52 and moved away from the pressing plate 51 together with the pressing plate 52. The outer glass S2 is sucked onto the pressing plate 82 and moved away from the pressing plate 81 together with the pressing plate 82, see intermediate step C in FIG. 11. The outer glass S1 provided with the spacer strand 14 is then conveyed into the pressing station 5 and joined there with the thin glass T to form a glass assembly U, see intermediate step D in FIG. 11. The joining takes place in the same way as described above for the glass assembly U1. The glass assembly U is then conveyed without turning through the turning station 6, see intermediate step E in FIG. 12, into the second application station 9. There, the spacer strand 15 is applied to the thin glass T so that a closed spacer frame is formed along the edge of the thin glass T in a manner known per se, see intermediate step F in FIG. 12. The glass assembly U is conveyed into the pressing station 8. The pressing plate 82 with the outer glass S2 sucked onto it is moved again in the direction of the pressing plate 81 until the outer glass S2 rests on the spacer strand 15, see intermediate step G in FIG. 12. The assembled triple insulating glass pane 10 is then transported away via the intermediate station 36.

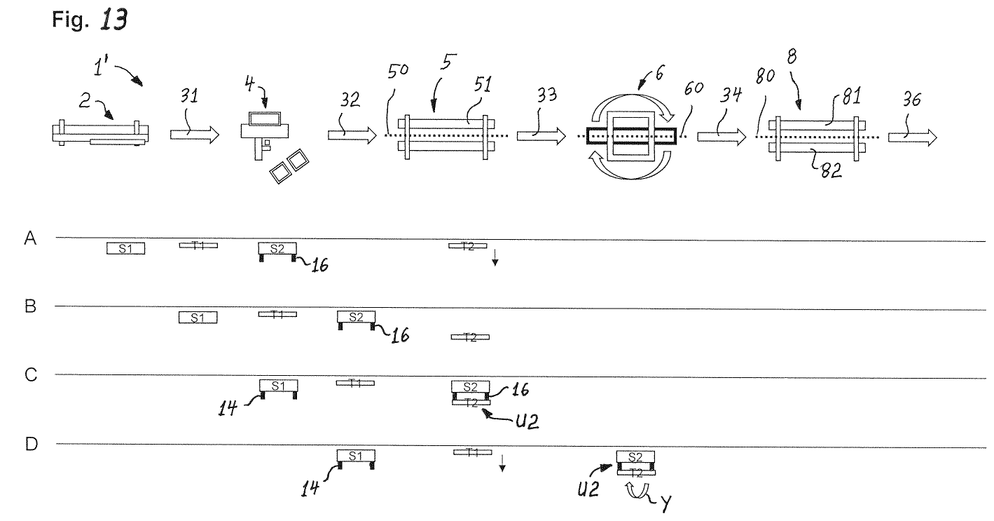

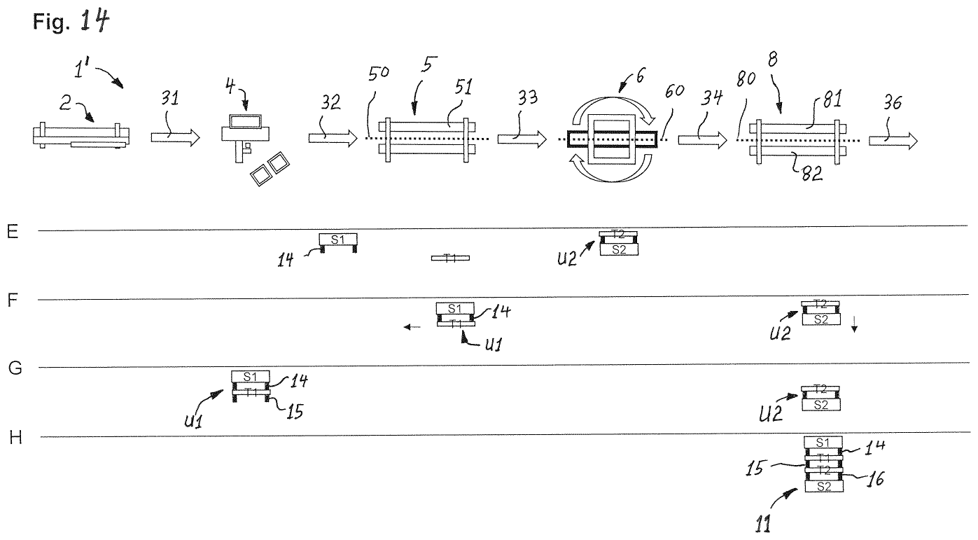

Alternatively, the quadruple insulating glass pane 11 can also be assembled using a modified device 1′ as shown in FIGS. 13 and 14. In contrast to the device 1 described above, the device 1′ does not contain a second application station 9. The glass assemblies U1, U2, see intermediate steps A to F of FIGS. 13 and 14, are produced in the same way as already described above with regard to intermediate steps A to F of FIGS. 1 and 2. Thereafter, the glass assembly U1 is conveyed back into the application station 4 in the opposite direction to the main conveying direction. In the application station 4, the spacer strand 15 is applied to the thin glass T1, so that a closed spacer frame is formed along the edge of the thin glass sheet T1 in a manner known per se, see intermediate step G in FIG. 14. In the pressing station 8, the glass assembly U2 is sucked onto the pressing plate 82 and moved away from the pressing plate 81. The glass assembly U1 provided with the spacer strand 15 is conveyed in the main conveying direction through the pressing station 5 and the turning station 6 into the pressing station 8. There, the glass assembly U1 is joined together with the glass assembly U2 in the appropriate manner to form the insulating glass pane 10, see intermediate step H in FIG. 14.

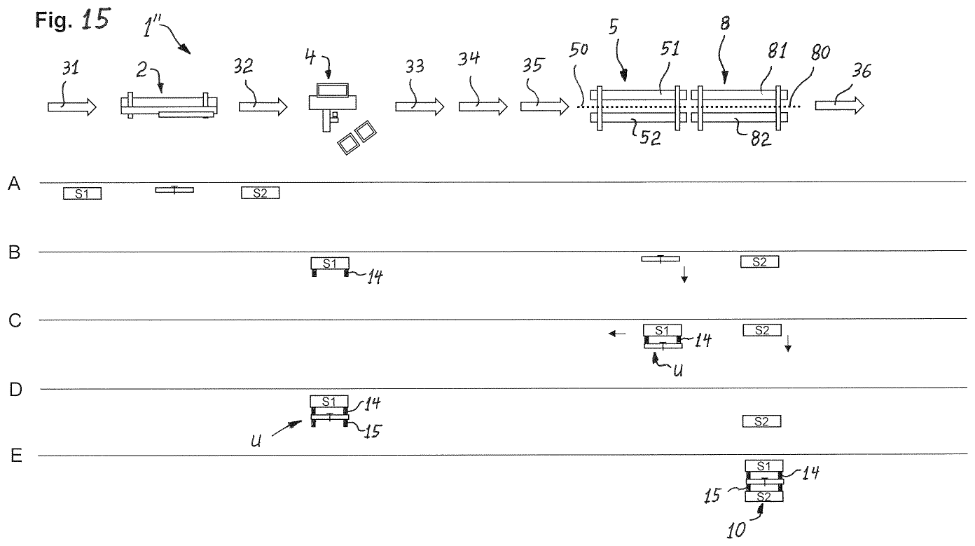

Alternatively, the triple insulating glass pane 10 can also be assembled using a modified device 1″ as shown in FIG. 15. Device 1″ differs from the device 1 described above primarily in that the two pressing stations 5 and 8 are arranged directly one behind the other. Furthermore, there is only one application station 4. The feeding of the glass sheets S2, T and S1 and the production of the glass assembly U (see intermediate steps A to C in FIG. 15) takes place in the same way as already described above in relation to intermediate steps A to D in FIG. 11. Thereafter, the glass assembly U is conveyed back into the application station 4 in the opposite direction to the main conveying direction. In the application station 4, the spacer strand 15 is applied to the thin glass T, so that a closed spacer frame is formed along the edge of the thin glass T in a manner known per se, see intermediate step D in FIG. 15. In the pressing station 8, the outer glass sheet S2 is sucked onto the pressing plate 82 and moved away from the pressing plate 81. The glass assembly U provided with the spacer strand 15 is conveyed in the main conveying direction through the pressing station 5 into the pressing station 8. There, the glass assembly U is joined with the outer glass S2 in the appropriate manner to form the insulating glass pane 10, see intermediate step E in FIG. 15.

The air ducts 57 in the pressing plate 51 can be pressurized with either negative or positive pressure. When pressurized with negative pressure, they form suction devices 90 in order to suck the flexible thin glass T, T1 and T2 as planar as possible onto the supporting surface 53. A suction device 90 comprises an air duct 57, a circular depression 91 and several grooves 92, see FIG. 9. The depression 91 surrounds the end duct section 572 and is connected to it. The depression 91 is open towards the supporting surface 54 and has a diameter of 20 mm or less. The grooves 92 extend radially toward the end duct section 572 and open into the depression 91. A groove 92 may comprise several groove sections 921 and 922. The two groove sections 921 and 922 extend at an angle to each other. The length L of a groove section 921, 922 extending in a straight line is at most 60 mm. The width B of the groove 92 is approximately 8 mm. The depth T of the depression 91 and the groove 92 is at most 1 mm. The depression 91 may be slightly deeper than the groove 92. The supporting surface 54 has a first supporting region 93, in which the air duct density is greater than in a second supporting region 94. This improves the air cushion transport of thin glass. In the first supporting region 93, the suctioned surface area fraction subjected to negative pressure by the air ducts 57 is greater than in the second supporting region 94. A suction device 90 contains four grooves 92 in the supporting region 93 and five grooves 92 in the supporting region 94. A third supporting region 95 is arranged in the region of a lower corner of the supporting wall 53, in which the suctioned surface area fraction is even greater than in the supporting region 93. This is achieved by the fact that some grooves 92 are connected to several air ducts 57 and intersect each other. The supporting wall 53 has holes 96 to accommodate sensors. The suction devices 90 leave out the regions of the holes 96.

With the suction devices 90 according to the invention, the thin glass T, T1 and T2 is initially sucked onto the first pressing plate 51 in the first pressing station 5. The design of the suction devices 90 can ensure that the thin glass T, T1, T2 lies against the supporting surface 54 particularly planar and without forming waves. Due to the different suction effects in the supporting regions 93, 94 and 95, the thin glass T, T1, T2 first contacts the supporting surface 54 in the supporting region 95. Starting from this corner, the thin glass T, T1, T2 then comes into contact with the supporting surface 54 in the supporting regions 93 and 94. This contact process starting from a corner of the thin glass T, T1, T2 results in a full-surface and particularly planar contact of the thin glass T, T1, T2 with the supporting surface 54. The formation of air cushions between the supporting surface 54 and the thin glass T, T1, T2, which would lead to a waviness of the thin glass T, T1, T2, is avoided. The suction of the thin glass T, T1, T2 onto the first pressing plate 51 is maintained while the respective thin glass T, T1, T2 is sucked onto the second pressing plate 52. Only after the respective thin glass T, T1, T2 has been sucked onto the second pressing plate 52, the suction to the first pressing plate 51 is terminated. As a result, the thin glass T, T1, T2 can be transferred to the second pressing plate 52 in a very planar manner and placed on the spacer 14 or 16, as already described above. The suction device in the second pressing plate 52 can be designed in a manner known per se or can include suction devices 90 according to the invention.

### LIST OF REFERENCE SYMBOLS

1, 1′, 1″ Device
10 Triple insulating glass pane
11 Quadruple insulating glass pane
T Thin glass sheet for 10
T1 First thin glass sheet for 11
T2 Second thin glass sheet for 11
S1 First outer glass sheet
S11 Surface/inside
S12 Surface/outside
S2 Second outer glass sheet
S21 Surface/inside
S22 Surface/outside
U Glass assembly for 10
U1 First glass assembly for 11
U2 Second glass assembly for 11
U21 Lower edge
14 First spacer strand
15 Second spacer strand
16 Third spacer strand
2 Inspection station
31-36 Intermediate stations
4 Application station
5 Pressing station
50 Horizontal conveyor
51 Pressing plate
52 Pressing plate
53 Supporting wall
54 Supporting surface
55 Vertical
56 Rubber coating
561 Oval hole
57 Air ducts
571 Duct section
572 End duct section
6 Turning station
61 Supporting wall
62 Supporting wall
63 Base frame
64 Rotary frame
65 Swivel joint
66 Axis of rotation
67 Guide rollers
68 Rotary drive
70 Tilting frame
71 Tilting joint
72 Tilting axis
73 Tilting drives
8 Pressing station
80 Horizontal conveyor
81 Pressing plate
82 Pressing plate
9 Application station
90 Suction device
91 Depression
92 Groove
921 Groove section
922 Groove section
93 Supporting region
94 Supporting region
95 Supporting region
96 Holes

What is claimed is:

1. A method for assembling an insulating glass pane containing two outer glasses and at least one thin glass lying between them, comprising the following steps:
in an application station, a first flexible spacer strand is applied to a first outer glass to form a first frame-shaped spacer;
after application of the first spacer strand, in a first pressing station, the first outer glass is joined with a thin glass to form a glass assembly, wherein the first pressing station is arranged downstream of the application station;
after the glass assembly has been joined together, a second flexible spacer strand is applied to the thin glass of the glass assembly to form a frame-shaped spacer;
after application of the second spacer strand, in a second pressing station, the glass assembly is completed with at least a second outer glass to form a triple or quadruple insulating glass pane, wherein the second pressing station is arranged downstream of the first pressing station.

2. The method according to claim 1, wherein the thin glass and the outer glass comprising the first spacer strand are conveyed upstandingly one after the other into the first pressing station, where they are joined together to form the glass assembly.

3. The method according to claim 2, comprising the following steps:
in the first pressing station, the thin glass supported by a first pressing plate is sucked onto a second pressing plate;
the second pressing plate with the thin glass sucked onto it is moved away from the first pressing plate;
after the thin glass has been moved away from the first pressing plate, the first outer glass is conveyed into the first pressing station, where it is supported by the first pressing plate;
after joining the thin glass and the first outer glass to form the glass assembly, the suction of the thin glass to the second pressing plate is terminated.

4. The method according to claim 3, comprising the following steps:
in the first pressing station, the thin glass supported by the first pressing plate is first sucked onto the first pressing plate;
the thin glass is sucked onto the second pressing plate before the suction of the thin glass onto the first pressing plate is terminated.

5. The method according to claim 1, comprising the following steps:
before the first spacer strand is applied to the first outer glass, the second outer glass and the thin glass are conveyed upstandingly one after the other through the application station;
the second outer glass is conveyed upstandingly into the second pressing station;
the thin glass is conveyed upstandingly into the first pressing station;
after application of the first spacer strand, the first outer glass is conveyed upstandingly from the application station into the first pressing station;
in the first pressing station, the thin glass and the first outer glass are joined together to form the glass assembly;
after the second spacer strand has been applied to the thin glass of the glass assembly, the glass assembly is conveyed upstandingly into the second pressing station;
in the second pressing station, the glass assembly and the second outer glass are joined together to form a triple insulating glass pane;
after joining, the triple insulating glass pane is conveyed upstandingly out of the second pressing station.

6. The method according to claim 5, comprising the following steps:
in the second pressing station, the second outer glass supported by a first pressing plate of the second pressing station is sucked onto a second pressing plate of the second pressing station;
the second pressing plate with the second outer glass sucked onto it is moved away from the first pressing plate;
after the second outer glass has been moved away from the first pressing plate, the glass assembly is conveyed into the second pressing station, where it is supported by the first pressing plate of the second pressing station;
after joining the second outer glass and the glass assembly, the suction of the second outer glass to the second pressing plate of the second pressing station is terminated;
after the suction of the second outer glass to the second pressing plate has been terminated, the triple insulating glass pane is conveyed out of the second pressing station.

7. The method according to claim 5, which is carried out with a first application station and a second application station;
wherein the first pressing station is arranged downstream of the first application station and the second application station is arranged between the first pressing station and the second pressing station between the turning station and the second pressing station;
wherein the first spacer strand is applied to the first outer glass in the first application station;
and wherein the glass assembly is conveyed into the second application station for application of the second spacer strand to the thin glass of the glass assembly.

8. The method according to claim 1, comprising the following steps:
a third flexible spacer strand is applied to the second outer glass to form a third frame-shaped spacer;
after the third spacer strand has been applied, the second outer glass is joined with a second thin glass to form a second glass assembly;
after the second glass assembly has been joined together and after the second spacer strand has been applied to the first glass assembly containing the first outer glass, the first glass assembly is joined together with the second glass assembly to form a quadruple insulating glass pane.

9. The method according to claim 8, comprising the following steps:
before the first spacer strand is applied and before the third spacer strand is applied, the second thin glass is conveyed upstandingly through the application station and into the first pressing station;
following the second thin glass, the second outer glass is conveyed upstandingly into the application station;
in the application station, the third flexible spacer strand is applied to the second outer glass;
after the third spacer strand has been applied, the second outer glass is conveyed upstandingly from the application station into the first pressing station;
in the first pressing station, the second thin glass and the second outer glass are joined together to form the second glass assembly;
following the second outer glass, the first thin glass is conveyed through the application station;
following the first thin glass, the first outer glass is conveyed upstandingly into the application station;
in the application station, the first flexible spacer strand is applied to the first outer glass;
after joining the second glass assembly, it is conveyed upstandingly from the first pressing station into a turning station, where it is turned about an upstanding axis of rotation;
following the second glass assembly, the first thin glass is conveyed upstandingly into the first pressing station;
after turning, the second glass assembly is conveyed upstandingly from the turning station into the second pressing station;
after the first spacer strand has been applied to the first outer glass, this is conveyed upstandingly from the application station into the first pressing station;
in the first pressing station, the first thin glass and the first outer glass are joined together to form the first glass assembly;
after joining the first glass assembly, the second flexible spacer strand is applied to the first thin glass of the first glass assembly;
after the second spacer strand has been applied to the first thin glass of the first glass assembly, the first glass assembly is conveyed upstandingly into the second pressing station;
in the second pressing station, the first glass assembly and the second glass assembly are joined together to form a quadruple insulating glass pane;
after joining, the quadruple insulating glass pane is conveyed upstandingly out of the second pressing station.

10. The method according to claim 8, which is carried out with a first application station and a second application station;
wherein the first pressing station is arranged downstream of the first application station and the second application station is arranged between the first pressing station and the second pressing station between the turning station and the second pressing station;
wherein the application of the first spacer strand to the first outer glass and the application of the third spacer strand to the second outer glass are carried out in the first application station;
and wherein the first glass assembly is conveyed into the second application station for application of the second spacer strand to the first thin glass of the first glass assembly.

11. The method according to claim 8, comprising the following steps:
in the second pressing station, the second outer glass of the second glass assembly, which is supported by the first pressing plate, is sucked onto a second pressing plate;
the second pressing plate with the second glass assembly sucked onto it is moved away from the first pressing plate;
after the second glass assembly has been moved away, the first glass assembly is conveyed into the second pressing station, where it is supported by the first pressing plate;
after the first glass assembly has been joined to the second glass assembly, the suction of the second outer glass to the second pressing plate is terminated;
after the suction of the second outer glass to the second pressing plate has been terminated, the quadruple insulating glass pane is conveyed out of the second pressing station.

12. The method according to claim 1, wherein at least one of the stations, being the first pressing station, has an air cushion supporting wall comprising a planar supporting surface, wherein a plurality of air ducts open into the supporting surface, and wherein an air flow emerges obliquely to the supporting surface from the air ducts when subjected to positive pressure.

13. The method according to claim 12, wherein the supporting surface comprises a first supporting region and a second supporting region, wherein an air duct density in the first supporting region is greater than in the second supporting region, and wherein the air duct density is defined as the number of air ducts per square meter of supporting surface.

14. The method according to claim 3, wherein at least one of the pressing plates, being the first pressing plate of the first pressing station, has a planar supporting surface into which a plurality of air ducts open, wherein the air ducts form suction devices when subjected to negative pressure, in order to suck a thin glass planar onto the supporting surface.
